(19) United States
(12) Patent Application Publication
(10) Pub. No.: US 2022/0087472 A1
(43) Pub. Date: Mar. 24, 2022

(54) Variable Level Steamer Insert

(71) Applicants: Gildardo Moncada, JR., Hereford, AZ (US); Raul Alfredo Moncada, Chandler, AZ (US)

(72) Inventors: Gildardo Moncada, JR., Hereford, AZ (US); Raul Alfredo Moncada, Chandler, AZ (US)

(21) Appl. No.: 17/480,153

(22) Filed: Sep. 21, 2021

Related U.S. Application Data
(60) Provisional application No. 63/081,189, filed on Sep. 21, 2020.

(51) Int. Cl. A47J 36/16; A47J 27/04; A47J 36/02

(52) U.S. Cl. CPC A47J 36/16; A47J 2027/043; A47J 36/02; A47J 27/04

(57) ABSTRACT

The Variable Level Steamer Insert is designed to be placed in an existing steamer pot. The Insert consists of a center tube and five plates that fit around the tube and can be assembled to add one, two, or three additional levels depending on the size and amount of food being steamed. The plates have a sleeve welded to the center which stabilizes the plates on the tube and the plates are held up with pins that are inserted into the holes of the tube, depending on the space that is needed between each plate. The center tube has holes the length of the tube and is capped with a removable cap. The steam exits the holes of the tube and allows the food to be evenly cooked in a convection method.

### BACKGROUND

The variable level steamer insert solves two different problems. First, it increases number of tamales that can be steamed at one time without smashing and deforming the bottom layer of tamales. Tamales are usually made in a big steamer in one or two layers. If one layer is used, then the number of tamales that can be steamed at one time is limited. If the tamales are stacked in order to steam more tamales simultaneously, the bottom tamales end up getting smashed and deformed in the process of steaming and the tamales do not cook evenly. The second problem that is solved is being able to steam multiple layers of foods without purchasing a completely new multi-level steamer. Other steamer systems have steamer sections that can be stacked on top of each other. The problem with this is you need to purchase an entirely new steamer system instead of using an existing pot.

For tamales, the Variable Level Steamer Insert can be inserted in an existing steamer pot. The first layer can be placed on the steamer insert, a plate is placed on top of the first layer of tamales, without smashing them, and a second layer of tamales can be placed on the plate, thereby increasing the amount of tamales that can be steamed by 100%. Depending on the size of the tamales and the size of the pot, a third layer may be added. The second problem can be demonstrated with seafood. In a typical steamer pot the seafood is packed all together, which bleeds the flavors of the seafood and limits the quantity of food that can be steamed at once. With the Variable Level Steamer Insert an existing pot can be used and up to 4 layers can be stacked, increasing the capacity by up to 300%, without having to stack the food directly on top of the lower layer.

### BRIEF SUMMARY OF THE INVENTION

The Variable Level Steamer Insert consists of 6 unique parts made of aluminum or stainless steel: a perforated center tube to distribute the steam; circular plates to hold the food and for a top cover; sleeve welded to the plate for stability; pins to hold up the plates; cap to force steam to exit the holes in the tube; wire handles to pick up the plates. It is intended to fit into an existing steamer pot and will increase the surface area for the food being steamed by as much as 300%. The steam that comes out of the holes in the tube will cook the food evenly in a convection method.

### BRIEF DESCRIPTION OF THE DRAWINGS

FIG. 1. FIG. 1 illustrates the Center Tube: Made of aluminum or stainless steel, 1.500 inches outside diameter, 1.47 inches inside diameter, 12.50 inches long with 0.257+−0.01 repeating holes drilled through. One set of holes starts one inch from the top end, one inch apart at 0-degree and 90-degree angles. The second set of holes starts 0.5 inches from the top end, one inch apart at 45-degree and 135-degree angles. The length of the tube will vary depending on the depth of the pot.

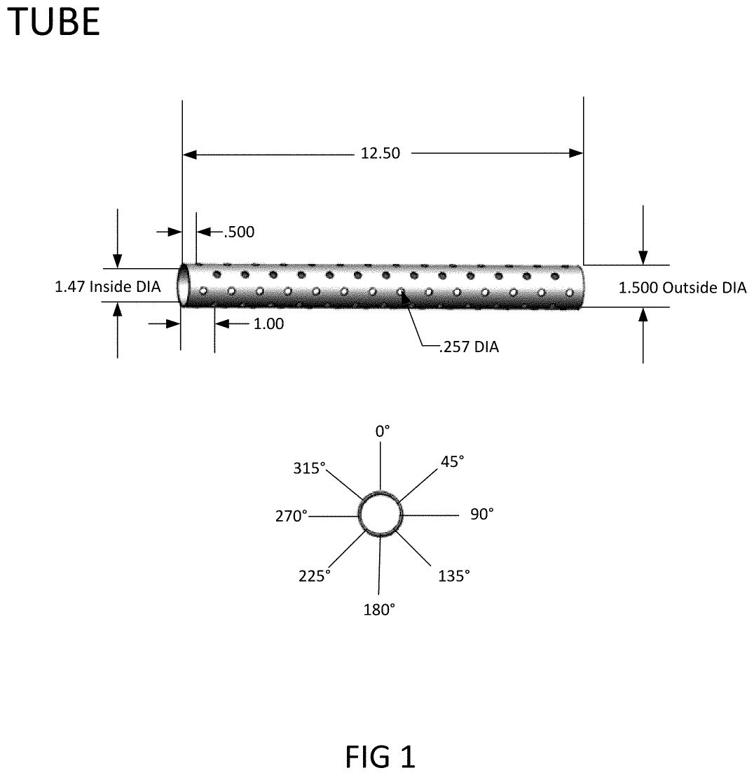

FIG. 2. FIG. 2 illustrates the Circular Plates: 1/16-gauge (0.06 inch) aluminum or stainless-steel sheet metal. The outside diameter varies depending on the inside diameter of the pot. Common diameter for the plates is 11 inches to 14.5 inches. The center hole of the circular plate has an inside diameter of 1.510+−0.01 inches through and the tube must fit through the inside diameter of the plate without interruption. The circular plates have two through slots on opposite ends. The slots are 0.125 inches wide and one inch long and are used for picking up the plates with a wire handles, which are included. The plate has four radial grooves to increase ridgedness.

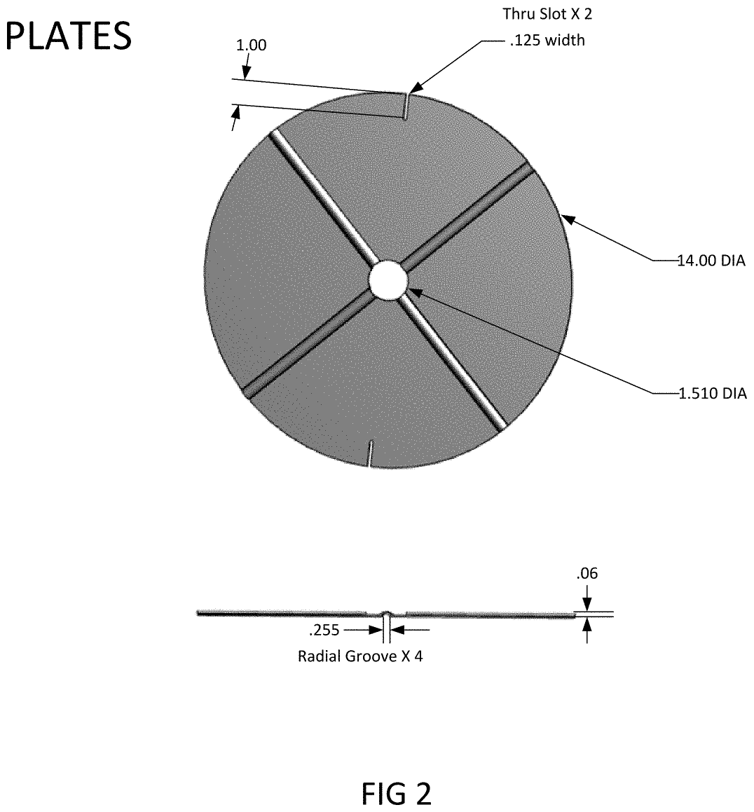

FIG. 3. FIG. 3 illustrates the Sleeve: The sleeve made of aluminum or stainless steel, 2.50 inches long and has an inside diameter of 1.509+0.005−0.000 through and an outside diameter of 1.620+−0.005 inches. The three sleeves sit at the bottom of the pot to hold the bottom plate off the bottom of the pot and out of the water.

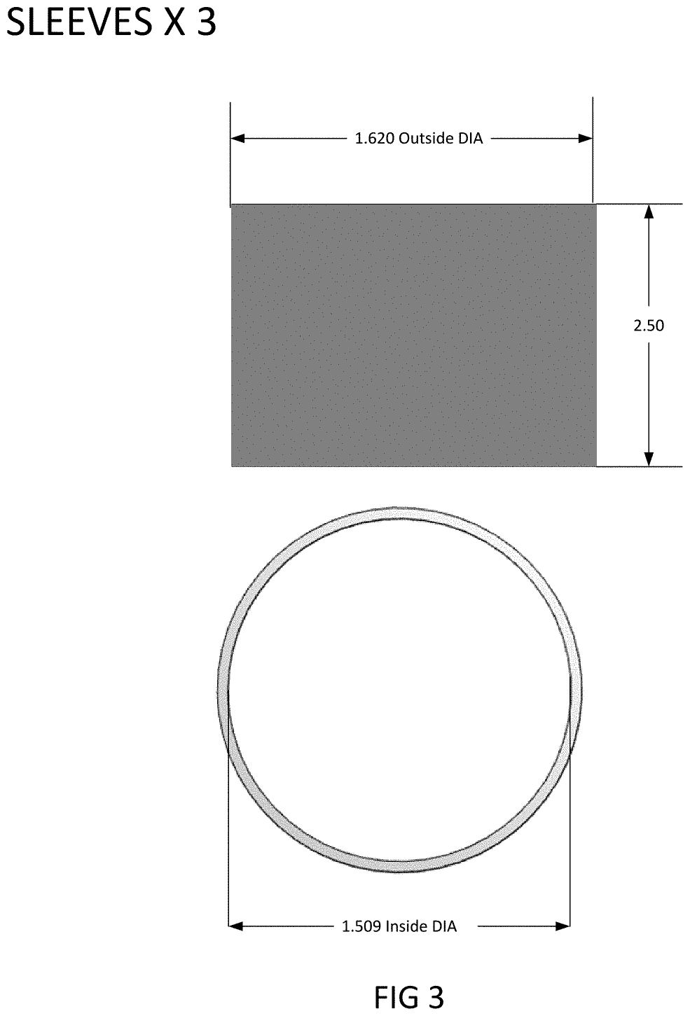

FIG. 4. FIG. 5 presents a Cap: The cap is solid aluminum or stainless steel. The part of the cap that goes inside the tube has an outside diameter of 1.370+−0.005 inches and 0.75 inches long. The part of the cap that sits on top of the tube has an outside diameter of 1.500 inches and is 0.250 inches long. The cap keeps the steam from exiting from the top and forces the steam to exit out of the holes in the tube. The weight of the solid cap allows it to stay in place without a pin.

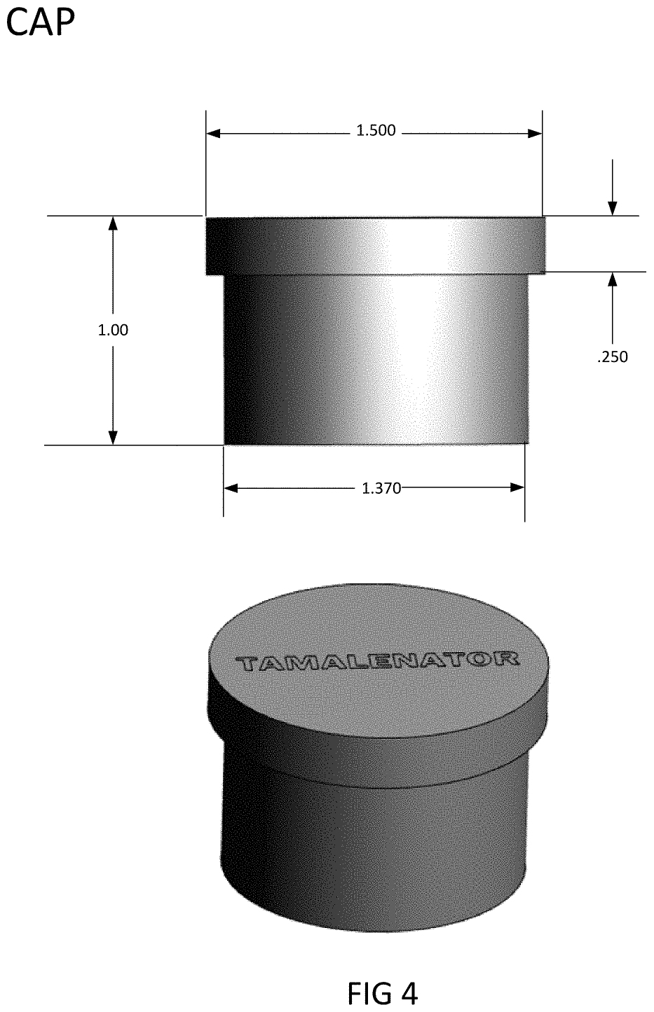

FIG. 5. FIG. 4 illustrates the Pin: Solid aluminum or stainless steel, 3.00 inches long, 0.250+−0.005 inches in diameter and must be smaller than the holes in the tube, as to fit through the holes in the tube without interruption.

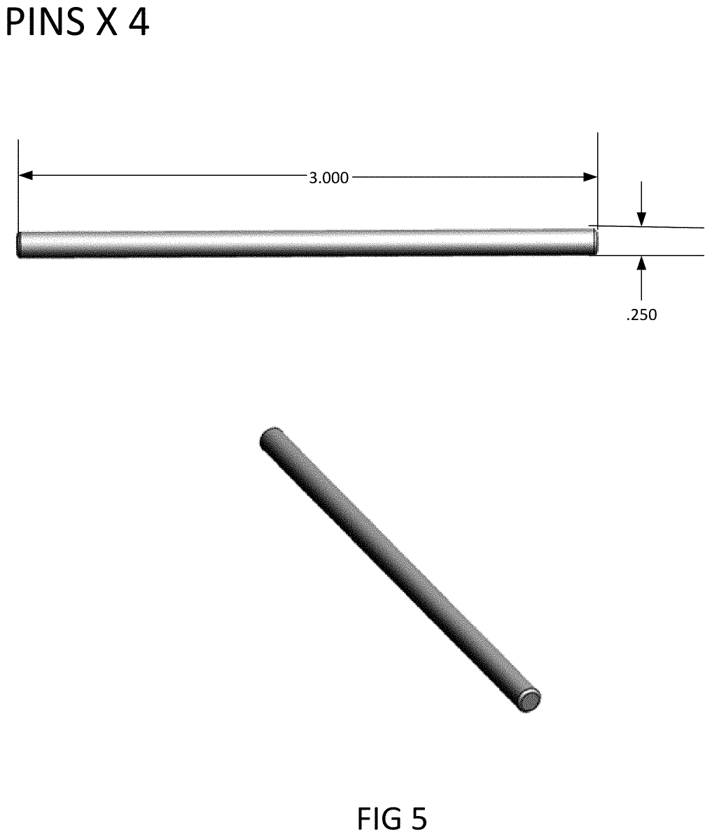

FIG. 6. FIG. 6 illustrates a Wire Handle: The wire handle is a solid wire, 0.06 inches in diameter, 12 inches long. The bottom of the wire is bent at a 90-degree angle at the 1.5-inch mark. The top of the handle is bent at a 90-degree angle at the 1.5-inch mark. The wire handle is used to lift the plates.

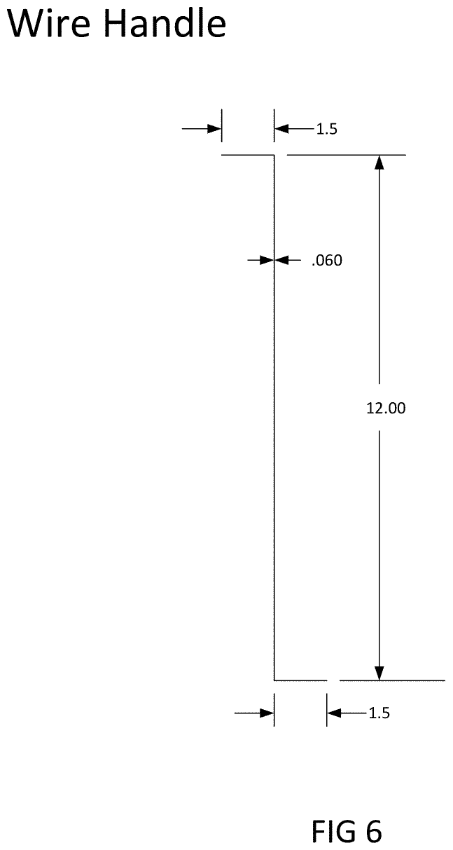

FIG. 7. FIG. 7 presents the complete assembly of the Variable Level Steamer Insert.

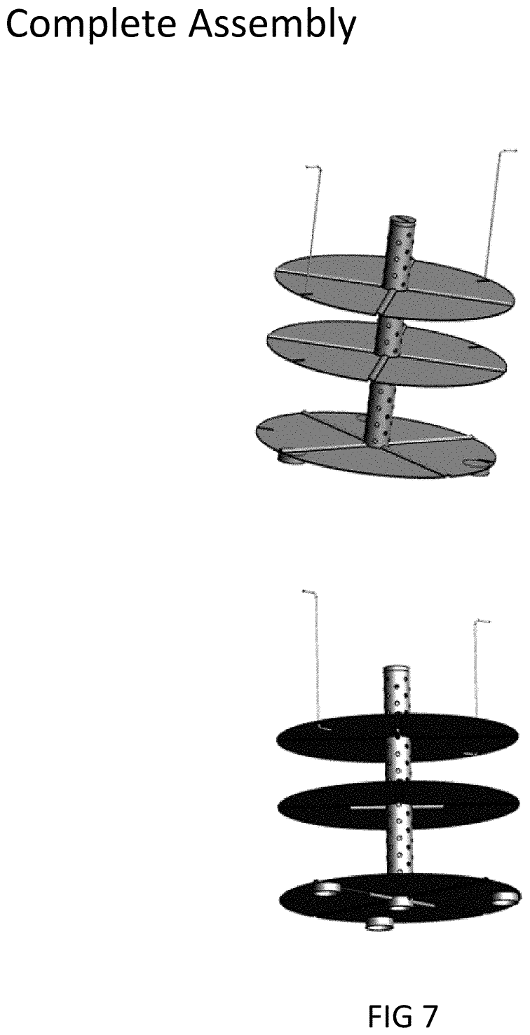

### DETAILED DESCRIPTION AND BEST MODE OF IMPLEMENTATION

The Variable Level Steamer Insert consists of 5 unique parts made of aluminum or stainless steel and is intended to fit into an existing steamer pot and increase the surface area for the food being steamed by as much as 300%. The insert has a center tube, 1.500 inches in outside diameter, 1.47 inches in inside diameter, approximately 12.50 inches long, which varies depending on the depth of the pot, and has 0.250+−0.01 repeating holes drilled through. One set of holes starts one inch from the top end, one inch apart at 0-degree and 90-degree angles. The second set of holes starts 0.5 inches from the top end, one inch apart at 45-degree and 135-degree angles. The holes function as the delivery of steam throughout the pot, circulating steam around the food in a convection method. The holes also hold the pins that holds the circular plates in position. The pins are solid, 0.250+−0.005 inches in diameter, 2.500 inches long and must be smaller than the holes in the tube, as to fit through the tube without interruption in the fit. There are 5 circular plates made from 1/16-gauge aluminum or stainless-steel sheet metal. The outside diameter varies from approximately 11 inches to 14.5 inches depending on the inside diameter of the pot. The center hole of the circular plate has an inside diameter of 1.510+−0.01 inches through and the tube must fit through the inside diameter of the plate without interruption. The circular plates have two through slots on opposite ends. The slots are 0.125 inches wide and one inch long and are used for picking up the plate with a wire handle, which is included. The wire handle is a solid wire, 0.06 inches in diameter, 12 inches long. The bottom of the wire is bent at a 90-degree angle at the one-inch mark. The top of the handle is bent in a swirled manner and starts bending at the four-inch mark from the top and is made this way to increase grip. The plate has a half inch long sleeve that is welded around the inside hole of the circular plates. The sleeve has an inside diameter of 1.509+0.005−0.000 through and an outside diameter of 1.620+−0.005 inches in diameter welded to the center of the plate for the purpose of stabilizing the plate on the center tube. Three to five plates can be used depending on the height of the food being steamed. The plates are stacked on top of each other on the tube in a vertical position with the distance from each other depending on the size of the food. The plates will be held in place by a pin that goes through the holes of the center tube. A food product that is 4 inches in height would use three plates with the first set of food product placed on the bottom plate, the second plate will hold the second set of food product and the third plate will be used as a top cover to keep the steam circulating around the food. A food product one inch in height can use five plates and will increase the steaming surface area by 300%. The design will allow the food to be steamed without the top food product smashing the bottom food product. The top of the tube contains a solid cap that fits inside the tube. The piece of the cap that goes inside the tube has a diameter of 1.370+−0.005 inches and 0.75 inches long. The top of the cap that sits on top of the tube is 1.500 inches in diameter and is 0.250 inches long. The purpose of the cap is to force the steam to exit out of the holes of the tube in order to cook in a convection method. The weight of the solid cap allows it to stay in place without a pin.

1. We claim, a device consisting of:
(a) six distinct parts made from aluminum or stainless steel that can be assembled with plates in various heights according to the height of the food that is being steamed, thereby
(b) allowing a higher quantity of food to be steamed at one time without the food being directly stacked on top of the lower layer, and
(c) the device can be placed in an existing steamer pot.
